(19) United States
(12) Patent Application Publication
(10) Pub. No.: US 2025/0375341 A1
(43) Pub. Date: Dec. 11, 2025

(54) MASSAGE MECHANISM OF MASSAGER

(71) Applicant: Shenzhen Hijoy Technology Co., Ltd., Shenzhen (CN)

(72) Inventor: Zhubiao SHAO, Shenzhen (CN)

(73) Assignee: Shenzhen Hijoy Technology Co., Ltd., Shenzhen (CN)

(21) Appl. No.: 19/300,618

(22) Filed: Aug. 14, 2025

(30) Foreign Application Priority Data
Jul. 28, 2025 (CN) 202521589508.X

(51) Int. Cl. A61H 7/00

(52) U.S. Cl. CPC A61H 7/004; A61H 2201/1215; A61H 2201/14; A61H 2201/1669

(57) ABSTRACT

A massage mechanism of a massager is provided, including a bracket; a first, second, and third massage portion are slidably mounted on the bracket; the first massage portion is provided with a first massage chamber, the second and third massage portions enclose to form a second massage chamber, and the first and second massage chambers are coaxially arranged; and the bracket is provided with a driving mechanism, the first, second, and third massage portions are respectively eccentrically connected to the driving mechanism, and the eccentric connection points of the second and third massage portions on the driving mechanism are arranged at an angle misalignment. The massage mechanism of the massager can simultaneously realize continuous reciprocating and rubbing massage on human body parts, forming a composite massage action, improving the massage comfort of human body massage parts, and enhancing the massage effect.

### RELATED APPLICATIONS

The present application claims the benefit of priority of Chinese Patent Application No. 202521589508.X, filed on Jul. 28, 2025, and entitled “MASSAGE MECHANISM OF MASSAGER,” the entire content of which is incorporated herein by reference.

### TECHNICAL FIELD

The present application relates to the technical field of massagers, and in particular to a massage mechanism of a massager.

### BACKGROUND

Massagers are mainly used to massage local parts of a human body to relieve physical fatigue for physical and mental relaxation. Existing massagers are usually designed with motors and transmission mechanisms to realize rotation, extension and retraction of the massage portion, thereby massaging a certain part of a human body. However, during actual massage, it may be impossible for some parts of the human body to be further inserted into the massager due to constraint from their relative positions, and simple rotating or retracting massage is mainly used for the inserted part. For existing massagers, when the above functions are integrated, the single motor can realize only one of the above functions, resulting in low massage comfort of human body during actual massage.

### SUMMARY

### (I) Technical Problem

The purpose of the present application is to provide a massage mechanism of a massager, which solves the problem that in the prior art, only a single power mechanism is configured, leading to a single massage action, no composite massage action can be achieved, resulting in poor massage comfort.

### (II) Technical Solution

In order to achieve the above purpose, the present application provides the following technical solution:

A massage mechanism of a massager includes a bracket; a first massage portion, a second massage portion, and a third massage portion are slidably mounted on the bracket; the first massage portion is provided with a first massage chamber, the second massage portion and the third massage portion enclose to form a second massage chamber, and the first massage chamber and the second massage chamber are coaxially arranged; and the bracket is provided with a driving mechanism, the first massage portion, the second massage portion, and the third massage portion are respectively eccentrically connected to the driving mechanism, and the eccentric connection points of the second massage portion and the third massage portion on the driving mechanism are arranged at an angle misalignment.

Preferably, the driving mechanism includes a first gear, a second gear, and a third gear rotatably mounted on the bracket, the second gear and the third gear are provided with a coaxial first rotation axis, the first gear is provided with a second rotation axis, the first rotation axis is arranged perpendicular to the second rotation axis, and the first gear is synchronously meshed with the second gear and the third gear; the first massage portion is eccentrically connected to the first gear, the second massage portion is eccentrically connected to the second gear, the third massage portion is eccentrically connected to the third gear, and the eccentric connection points on the second gear and the third gear are arranged at an angle misalignment; and a motor is mounted on the bracket, and the first gear is connected to an output shaft of the motor.

Preferably, the first gear is provided with a first eccentric shaft, and the first massage portion includes a front bracket seat slidably mounted on the bracket, and a strip hole is opened at the bottom of the front bracket seat, and the first eccentric shaft extends into the strip hole.

Preferably, the first massage portion includes a front bracket fixed on the front bracket seat, the front bracket is provided with an inner ring layer and an outer ring layer coaxially arranged, and a connecting portion evenly distributed along a circumferential direction is provided between the inner ring layer and the outer ring layer.

Preferably, the inner ring layer and the outer ring layer are configured to embed a flexible massage ring.

Preferably, the second massage portion includes a first slider, the third massage portion includes a second slider, and both the first slider and the second slider are slidably mounted on the bracket; a second eccentric shaft is provided on the second gear, a first pull rod is rotatably connected to the second eccentric shaft, and an end of the first pull rod is rotatably connected to the first slider; and the third gear is provided with a third eccentric shaft, the third eccentric shaft is rotatably connected to a second pull rod, and an end of the second pull rod is rotatably connected to the second slider.

Preferably, the second massage portion includes a first rubbing bracket fixed on the first slider, the second massage portion includes a second rubbing bracket fixed on the second slider, the first rubbing bracket and the second rubbing bracket are both equipped with flexible massage portions of a semi-ring structure, and the two flexible massage portions enclose to form a second massage chamber.

Preferably, two parallel upper guide rods are equipped on the top of the bracket, and two parallel lower guide rods are equipped on the bottom of the bracket; and the front bracket seat is slidably equipped on the two upper guide rods, the first slider is equipped on the upper guide rod and the lower guide rod located on one side of the bracket, and the second slider is equipped on the upper guide rod and the lower guide rod located on the other side of the bracket.

Preferably, the bracket is provided with a mounting cavity, the motor is equipped in the mounting cavity, and a protective housing is equipped on the mounting cavity.

Preferably, the motor is a brushed motor or a brushless motor.

Preferably, a battery and a circuit board are further equipped in the mounting cavity.

Preferably, the protective housing is provided with a positioning portion extending into the mounting cavity, and the positioning portion is sleeved with a sealing ring that fits an inner wall of the mounting cavity.

Preferably, a weight-reducing cavity is provided on the bracket at a position located on one side of the mounting cavity, and mesh ribs and connecting columns are provided in the weight-reducing cavity.

Preferably, all the first gear, the second gear, and the third gear are bevel gears.

Preferably, the first gear is a crown gear, and the second gear and the third gear are spur gears.

Preferably, the first gear is a spur gear, and the second gear and the third gear are crown gears.

### (III) Beneficial Effects

The massage mechanism of the massager drives the first massage portion, the second massage portion, and the third massage portion to realize reciprocating sliding relative to the bracket by means of a driving mechanism. With a human body part extends into the first massage chamber and the second massage chamber, the driving mechanism drives the first massage portion to independently reciprocate and massage the human body part located in the first massage chamber, while the second massage portion and the third massage portion realize staggered reciprocating movement due to the angle misalignment setting of the eccentric connection point. That is, the human body part located in the second massage chamber is subjected to staggered rubbing massage. Thus, continuous reciprocating massage and staggered rubbing massage of a human body part can be achieved at the same time, forming a composite massage action, improving the massage comfort of human body massage parts, and enhancing the massage effect.

### BRIEF DESCRIPTION OF THE DRAWINGS

FIG. 1 is a schematic diagram of a first-view three-dimensional structure according to an embodiment of the present application.

FIG. 2 is a schematic diagram of a second-view three-dimensional structure according to an embodiment of the present application.

FIG. 3 is a schematic diagram of an exploded structure according to an embodiment of the present application.

FIG. 4 is a schematic diagram of a first-view structure of a driving mechanism according to an embodiment of the present application.

FIG. 5 is a schematic diagram of a second-view structure of a driving mechanism according to an embodiment of the present application.

FIG. 6 is a schematic diagram of a structure of a front bracket seat according to an embodiment of the present application.

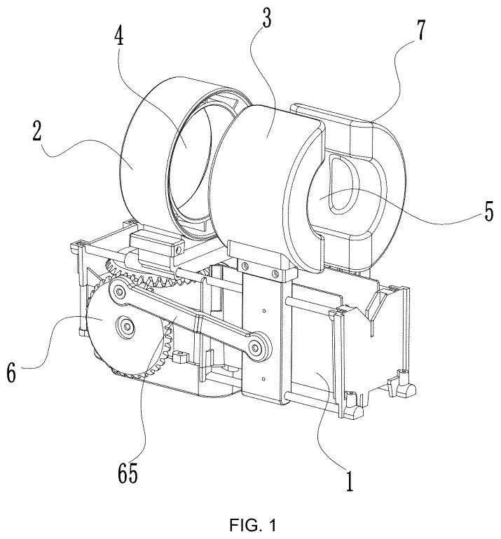

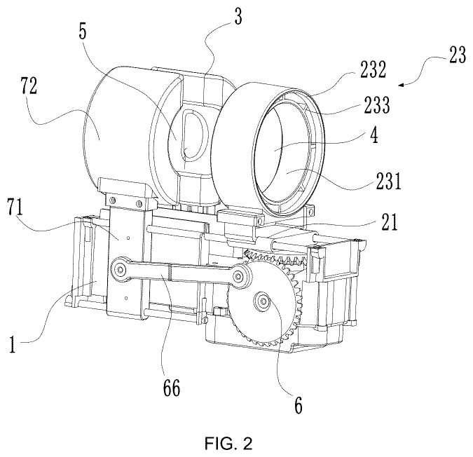

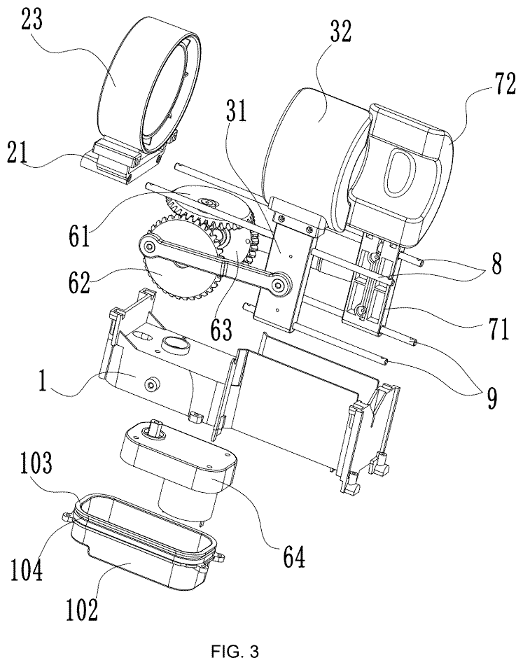

In FIG. 1 to FIG. 6, the following component names or lines correspond to the following reference numerals:

bracket 1, mounting cavity 101, protective housing 102, positioning portion 103, sealing ring 104, weight-reducing cavity 105, mesh rib 106, connecting column 107, first massage portion 2, front bracket seat 21, strip hole 22, front bracket 23, inner ring layer 231, outer ring layer 232, connecting portion 233, second massage portion 3, first slider 31, first rubbing bracket 32, first massage chamber 4, second massage chamber 5, driving mechanism 6, first gear 61, first eccentric shaft 610, second gear 62, second eccentric shaft 620, third gear 63, third eccentric shaft 630, motor 64, first pull rod 65, second pull rod 66, third massage portion 7, second slider 71, second rubbing bracket 72, upper guide rod 8, lower guide rod 9.

### DETAILED DESCRIPTION

The technical solutions in embodiments of the present application will be explicitly and completely described below with reference to drawings of the embodiments. It should be understood that the embodiments described are only part of the embodiments of the present application, rather than all embodiments.

As shown in FIGS. 1 to 3, a massage mechanism of a massager is provided in an embodiment of the present application, which is used to be equipped in a massager and perform main massage actions on human body parts. Specifically, it includes a bracket 1; a first massage portion 2, a second massage portion 3, and a third massage portion 7 are slidably mounted on the bracket 1; the first massage portion 2 is provided with a first massage chamber 4, the second massage portion 3 and the third massage portion 7 enclose to form a second massage chamber 5, the first massage chamber 4 and the second massage chamber 5 are coaxially arranged, and human body parts extend into the first massage chamber 4 and the second massage chamber 5 during massage. Specifically, the first massage chamber 4 and the second massage chamber 5 are arranged in sequence and coaxially to ensure that no non-axial force is generated on the human body during the action, thereby ensuring safety during the massage process.

The first massage portion 2, the second massage portion 3, and the third massage portion 7 can all slide relative to the bracket 1 to realize a reciprocating massage action. Specifically, the bracket 1 is provided with a driving mechanism 6, the first massage portion 2, the second massage portion 3, and the third massage portion 7 are respectively eccentrically connected to the driving mechanism 6, and the eccentric connection points of the second massage portion 3 and the third massage portion 7 on the driving mechanism 6 are arranged at an angle misalignment; the driving mechanism 6 is configured to drive the first massage portion 2, the second massage portion 3, and the third massage portion 7 to reciprocate synchronously, in which the first massage portion 2 performs an independent reciprocating massage action on a human body part, and since the eccentric connection point at which the second massage portion 3 and the third massage portion 7 are connected to the driving mechanism 6 has an angle misalignment, so that the second massage portion 3 and the third massage portion 7 perform staggered movements on the human body part to produce a rubbing action. That is, the reciprocating actions of the second massage portion 3 and the third massage portion 7 are not synchronized, so as to realize independent reciprocating massage and rubbing massage actions on human body parts, forming a composite massage action on human body parts, thereby improving the massage comfort of human body parts and enhancing the massage effect.

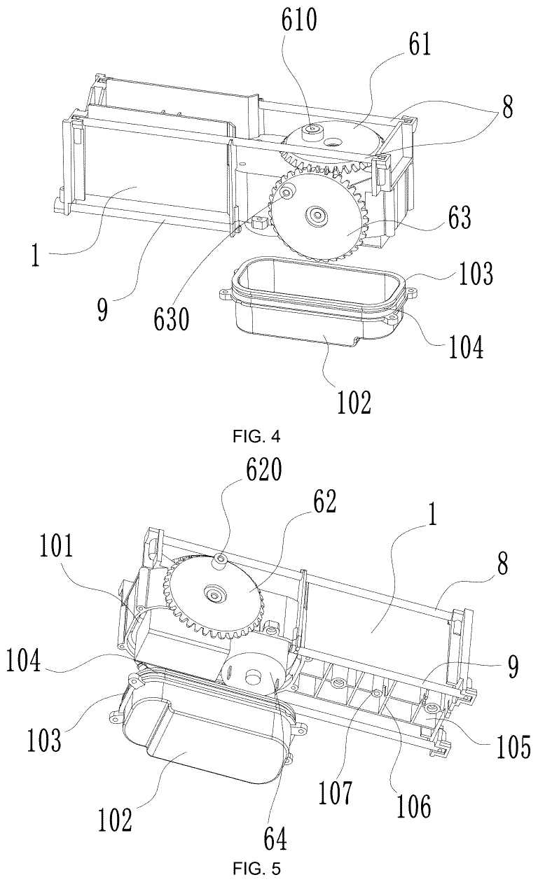

When the driving mechanism 6 is activated, it forms independent action drives for the first massage portion 2, the second massage portion 3, and the third massage portion 7. Specifically, as shown in FIGS. 4 and 5, the driving mechanism 6 includes a first gear 61, a second gear 62, and a third gear 63 rotatably mounted on the bracket 1, the second gear 62 and the third gear 63 are provided with a coaxial first rotation axis, the first gear 61 is provided with a second rotation axis, the first rotation axis is arranged perpendicular to the second rotation axis, and the first gear 61 is synchronously meshed with the second gear 62 and the third gear 63, where a motor 64 is mounted on the bracket 1, and the first gear 61 is connected to an output shaft of the motor 64; when the motor 64 drives the first gear 61 to rotate, it drives the second gear 62 and the third gear 63 to rotate synchronously, that is, when the motor 64 is in action, the first gear 61, the second gear 62, and the third gear 63 rotate simultaneously and are equipped according to the sliding positions of the first massage portion 2, the second massage portion 3, and the third massage portion 7, thereby realizing the overall miniaturization of the driving mechanism 6 and reducing the power source. In addition, the synchronization of massage actions can help improve the massage effect.

The first gear 61, the second gear 62, and the third gear 63 act synchronously, and various embodiments can be adopted to integrate them while meeting the requirements of a smaller occupied space. In the first embodiment, the first gear 61, the second gear 62, and the third gear 63 are all bevel gears. In the second embodiment, let the first gear 61 be a crown gear, and the second gear 62 and the third gear 63 be spur gears. In the third embodiment, let the first gear 61 be a spur gear, and the second gear 62 and the third gear 63 be crown gears. The gear type of a specific application can also be other types, such as worm and worm wheel matching methods. The main consideration is to realize that the first gear 61 synchronously drives the second gear 62 and the third gear 63 to rotate in directions perpendicular to each other on the axis, so that it can be equipped and used in a smaller space.

Among them, the first massage portion 2 is eccentrically connected to the first gear 61, the second massage portion 3 is eccentrically connected to the second gear 62, and the third massage portion 7 is eccentrically connected to the third gear 63. The eccentric connection points on the second gear 62 and the third gear 63 are arranged at an angle misalignment. Since the first massage portion 2, the second massage portion 3, and the third massage portion 7 are all slidably mounted on the bracket 1, therefore, the eccentric connection points on the first gear 61, the second gear 62, and the third gear 63 are used to rotate one circle to realize the periodic reciprocating massage action of the first massage portion 2, the second massage portion 3, and the third massage portion 7, thereby allowing the massage action to be based on pre-designed actions to ensure a good massage effect when massaging the human body.

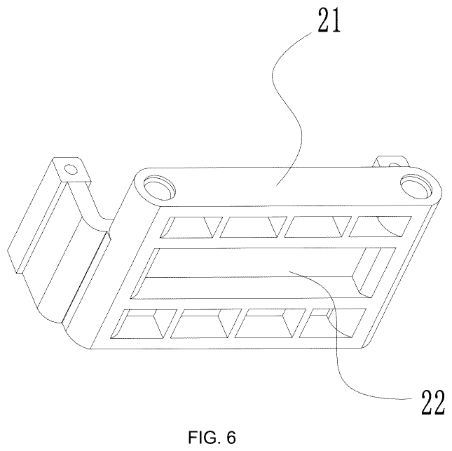

Specifically, the first gear 61 is provided with a first eccentric shaft 610, and the first massage portion 2 includes a front bracket seat 21 slidably mounted on the bracket 1. As shown in FIG. 6, a strip hole 22 is opened at the bottom of the front bracket seat 21, and the first eccentric shaft 610 extends into the strip hole 22. The entire first massage portion 2 is slidably mounted on the bracket 1 by means of the front bracket 21, and the first eccentric shaft 610 on the first gear 61 extends into the strip hole 22 on the front bracket seat 21. Thus, when the first gear 61 rotates, an inner wall of the strip hole 22 on the front bracket seat 21 is pushed by the first eccentric shaft 610 to drive the first massage portion 2 to reciprocate on the bracket 1.

Among them, the first massage portion 2 includes a front bracket 23 fixed on the front bracket seat 21, the front bracket 23 is provided with an inner ring layer 231 and an outer ring layer 232 coaxially arranged, a connecting portion 233 evenly distributed along a circumferential direction is provided between the inner ring layer 231 and the outer ring layer 232, and the inner ring layer 231 and the outer ring layer 232 are configured to embed a flexible massage ring; the front bracket 23 reciprocates with the flexible massage ring to form a reciprocating massage action on a human body part.

Specifically, the second massage portion 3 includes a first slider 31, the third massage portion 7 includes a second slider 71, and both the first slider 31 and the second slider 71 are slidably mounted on the bracket 1; a second eccentric shaft 620 is provided on the second gear 62, a first pull rod 65 is rotatably connected to the second eccentric shaft 620, and an end of the first pull rod 65 is rotatably connected to the first slider 31. Moreover, the third gear 63 is provided with a third eccentric shaft 630, the third eccentric shaft 630 is rotatably connected to a second pull rod 66, and an end of the second pull rod 66 is rotatably connected to the second slider 71. When the second gear 62 and the third gear 63 are rotated by the first gear 61, the second eccentric shaft 620 swings with the first pull rod 65 and pulls the first slider 31 to reciprocate. Similarly, the third eccentric shaft 630 on the third gear 63 swings with the second pull rod 66 and pulls the second slider 71 to reciprocate.

The second eccentric shaft 620 and the third eccentric shaft 630 are configured to drive the first pull rod 65 and the second pull rod 66 to swing respectively when rotating, so as to drive the first slider 31 and the second slider 71 to reciprocate on the bracket 1. Since the second eccentric shaft 620 and the third eccentric shaft 630 are set at an angle misalignment during mounting, the second massage portion 3 and the third massage portion 7 can form a staggered movement to simulate reciprocating rubbing. When a human body part is massaged by the first massage portion 2 in a reciprocating manner, the rubbing massage applied by the second massage portion 3 and the third massage portion 7 is increased at the same time to enhance the massage effect.

Specifically, the second massage portion 3 includes a first rubbing bracket 321 fixed on the first slider 31, the second massage portion 3 includes a second rubbing bracket 721 fixed on the second slider 71, the first rubbing bracket 321 and the second rubbing bracket 721 are both equipped with flexible massage portions of a semi-ring structure, and the two flexible massage portions enclose to form a second massage chamber 5. The first rubbing bracket 321 and the second rubbing bracket 721 are used to integrate the flexible massage portion to cover the human body part. Thus, the human body parts feel soft during rubbing massage, and discomfort to the human body parts is avoided.

In order to ensure that the front bracket seat 21, the first slider 31, and the second slider 71 can slide stably, as shown in FIGS. 4 and 5, two parallel upper guide rods 8 are equipped on the top of the bracket 1, and two parallel lower guide rods 9 are equipped on the bottom of the bracket 1, in which the front bracket seat 21 is slidably equipped on the two upper guide rods 8, the first slider 31 is equipped on the upper guide rod 8 and the lower guide rod 9 located on one side of the bracket 1, and the second slider 71 is equipped on the upper guide rod 8 and the lower guide rod 9 located on the other side of the bracket 1. The front bracket seat 21 is supported and guided to slide by two upper guide rods 8, and the first slider 31 and the second slider 71 are supported and guided to slide on both sides of the bracket 1 by the cooperation of the upper guide rod 8 and the lower guide rod 9, thereby allowing the front bracket seat 21, the first slider 31, and the second slider 71 to slide independently when driven to slide without interference with each other, and the common upper guide rod 8 and the lower guide rod 9 can also be integrated in a smaller volume.

Moreover, as shown in FIG. 5, a mounting cavity 101 is opened on the bracket 1, the motor 64 is equipped in the mounting cavity 101, and a protective housing 102 is equipped on the mounting cavity 101 to facilitate the mounting and maintenance of the motor 64. The protective housing 102 protects the internal electrical-related parts to prevent water from entering the interior during use.

In order to ensure the power of the motor 64, it is also possible to combine the power supply line of the motor 64 in a way that facilitates connection. The motor 64 can be a brushed motor 64 or a brushless motor 64.

Moreover, a battery and a circuit board are further equipped in the mounting cavity 101. Of course, other circuit devices can be further integrated, which is convenient for integrating and mounting the electrical part in the mounting cavity 101 with better protection effect. With regard to specific circuit part related to controlling the motor 64 and the battery, the existing technology can be adopted.

In order to ensure the sealing and protection performance of the protective housing 102 against the mounting cavity 101, a positioning portion 103 extending into the mounting cavity 101 is provided on the protective housing 102, and a sealing ring 104 that fits an inner wall of the mounting cavity 101 is sleeved on the positioning portion 103. The sealing portion extending into the mounting cavity 101 is added by the positioning portion 103, and good sealing is achieved by sleeved with the sealing ring 104 to improve the protection effect.

The bracket 1 generally is an integrated injection molding structure. During the molding process, the mounting connection structure can be molded and material reduction treatment can also be performed. Specifically, a weight-reducing cavity 105 is provided on the bracket 1 at a position located on one side of the mounting cavity 101, and mesh ribs 106 and connecting columns 107 are provided in the weight-reducing cavity 105. The connecting columns 107 are used to mount the entire bracket 1 in a massager. The mesh ribs 106 are used to further strengthen the structural strength of the bracket 1 after reducing materials, and the connecting column 107 is generally provided with threaded holes for mounting in the massager by fasteners.

The massage mechanism proposed in this embodiment can be integrated into different types of massagers, mainly to realize the integration of independent reciprocating massage actions and rubbing massage actions, and improve the massage effect on the human body parts inserted into the massager.

In the present application, unless otherwise specified or restricted, the terms of “mount”, “be connected to”, “be connected with” and “fix” shall be understood as a general sense. For example, the connection can be fixed connection, removable connection, integrated connection, mechanical connection, electrical connection, direct connection, indirect connection through intermediate media, connection between two components or interaction between two components. Persons of ordinary skill in the art can understand the specific meanings of the above terms in the present application as appropriate.

In the description of the present application, it needs to be noted that the azimuth or position relationships indicated by the terms “center”, “upper”, “lower”, “left”, “right”, “inside” and “outside” are based on those shown in the drawings, or those in which a product of the present application is usually placed when used. It is only for convenience of description and simplification of the present application, not to indicate or imply that the referred devices or components must have a specific orientation, be constructed and operate in a specific orientation, and thus cannot be understood as limiting the present application. Furthermore, the terms “first” and “second” are used for distinguishing purposes only and cannot be understood as indicating or implying relative importance.

It is obvious to those skilled in the art that the present application is not limited to the details of the above exemplary embodiment, and can be implemented in other specific forms without departing from the spirit or basic features of the present application. Therefore, no matter from which point of view, the embodiment should be regarded as exemplary and non-limiting. The scope of the present application is defined by the claims rather than the above description, so it is intended to include all changes that fall within the meaning and scope of the equivalent elements of the claims in the present application. Any reference numerals in the claims should not be regarded as limiting the claims involved.

What is claimed is:

1. A massage mechanism of a massager, comprising a bracket, wherein a first massage portion, a second massage portion, and a third massage portion are slidably mounted on the bracket; the first massage portion is provided with a first massage chamber, the second massage portion and the third massage portion enclose to form a second massage chamber, and the first massage chamber and the second massage chamber are coaxially arranged; and
the bracket is provided with a driving mechanism, the first massage portion, the second massage portion, and the third massage portion are respectively eccentrically connected to the driving mechanism, and the eccentric connection points of the second massage portion and the third massage portion on the driving mechanism are arranged at an angle misalignment.

2. The massage mechanism of a massager according to claim 1, wherein the driving mechanism comprises a first gear, a second gear, and a third gear rotatably mounted on the bracket, the second gear and the third gear are provided with a coaxial first rotation axis, the first gear is provided with a second rotation axis, the first rotation axis is arranged perpendicular to the second rotation axis, and the first gear is synchronously meshed with the second gear and the third gear;
the first massage portion is eccentrically connected to the first gear, the second massage portion is eccentrically connected to the second gear, the third massage portion is eccentrically connected to the third gear, and the eccentric connection points on the second gear and the third gear are arranged at an angle misalignment; and
a motor is mounted on the bracket, and the first gear is connected to an output shaft of the motor.

3. The massage mechanism of a massager according to claim 2, wherein the first gear is provided with a first eccentric shaft, and the first massage portion comprises a front bracket seat slidably mounted on the bracket, and a strip hole is opened at the bottom of the front bracket seat, and the first eccentric shaft extends into the strip hole.

4. The massage mechanism of a massager according to claim 3, wherein the first massage portion comprises a front bracket fixed on the front bracket seat, the front bracket is provided with an inner ring layer and an outer ring layer coaxially arranged, and a connecting portion evenly distributed along a circumferential direction is provided between the inner ring layer and the outer ring layer.

5. The massage mechanism of a massager according to claim 4, wherein the inner ring layer and the outer ring layer are configured to embed a flexible massage ring.

6. The massage mechanism of a massager according to claim 3, wherein the second massage portion comprises a first slider, the third massage portion comprises a second slider, and both the first slider and the second slider are slidably mounted on the bracket;
a second eccentric shaft is provided on the second gear, a first pull rod is rotatably connected to the second eccentric shaft, and an end of the first pull rod is rotatably connected to the first slider; and
the third gear is provided with a third eccentric shaft, the third eccentric shaft is rotatably connected to a second pull rod, and an end of the second pull rod is rotatably connected to the second slider.

7. The massage mechanism of a massager according to claim 6, wherein the second massage portion comprises a first rubbing bracket fixed on the first slider, the second massage portion comprises a second rubbing bracket fixed on the second slider, the first rubbing bracket and the second rubbing bracket are both equipped with flexible massage portions of a semi-ring structure, and the two flexible massage portions enclose to form a second massage chamber.

8. The massage mechanism of a massager according to claim 6, wherein two parallel upper guide rods are equipped on the top of the bracket, and two parallel lower guide rods are equipped on the bottom of the bracket; and
the front bracket seat is slidably equipped on the two upper guide rods, the first slider is equipped on the upper guide rod and the lower guide rod located on one side of the bracket, and the second slider is equipped on the upper guide rod and the lower guide rod located on the other side of the bracket.

9. The massage mechanism of a massager according to claim 8, wherein the bracket is provided with a mounting cavity, the motor is equipped in the mounting cavity, and a protective housing is equipped on the mounting cavity.

10. The massage mechanism of a massager according to claim 9, wherein the motor is a brushed motor or a brushless motor.

11. The massage mechanism of a massager according to claim 10, wherein a battery and a circuit board are further equipped in the mounting cavity.

12. The massage mechanism of a massager according to claim 10, wherein the protective housing is provided with a positioning portion extending into the mounting cavity, and the positioning portion is sleeved with a sealing ring that fits an inner wall of the mounting cavity.

13. The massage mechanism of a massager according to claim 12, wherein a weight-reducing cavity is provided on the bracket at a position located on one side of the mounting cavity, and mesh ribs and connecting columns are provided in the weight-reducing cavity.

14. The massage mechanism of a massager according to claim 2, wherein all the first gear, the second gear, and the third gear are bevel gears.

15. The massage mechanism of a massager according to claim 2, wherein the first gear is a crown gear, and the second gear and the third gear are spur gears.

16. The massage mechanism of a massager according to claim 2, wherein the first gear is a crown gear, and the second gear and the third gear are spur gears.
